(19) United States
(12) Patent Application Publication
(10) Pub. No.: US 2007/0057232 A1
(43) Pub. Date: Mar. 15, 2007

(54) Luminant powder and method for producing the same

(75) Inventor: Jen-Ho Shih, Taipei City (TW)

Correspondence Address: BACON & THOMAS, PLLC, 625 SLATERS LANE, FOURTH FLOOR, ALEXANDRIA, VA, 22314, US

(73) Assignee: GIFTSTAR TRADE MARK DESIGN INC, Taipei city (TW)

(21) Appl. No.: 11/316,820

(22) Filed: Dec. 27, 2005

(30) Foreign Application Priority Data
Sep. 15, 2005 (TW) 94131811

(51) Int. Cl. B05D 7/00; C09K 11/08

(52) U.S. Cl. 252/301.4 R; 427/212; 252/301.4 S; 252/301.4 P; 252/301.4 F; 252/301.4 H; 252/301.5; 252/301.6 R; 252/301.6 S; 252/301.6 P; 252/301.6 F; 428/403

(57) ABSTRACT

The present invention relates to a luminant powders and method for producing the same. The method utilizes winnowing to sieve luminant powders with required particle size out. Further, the present invention discloses a method for coating the powders with phosphoric acid to increase the stability and acquire long-term light resistance and superior luminant property.

### BACKGROUND OF THE INVENTION

1. Field of the Invention

The present invention relates to light storing luminant powders, method for producing the same and its applications.

2. Description of Prior Art

General luminant objects have limited luminant life. Without exterior light sources and stimulations, the luminosity decays along time rapidly. Different from general luminant objects, some light storing luminant objects or phosphorous luminant objects keep long time emission after stop providing exterior light sources and stimulations.

Light storing luminant powders emit fluorescent in the dark or at night after absorbing energy from light sources. Hence, it can be used for demonstration and illumination at night. It can be used for night or indoor large-scaled activity as well. Common known light storing luminant powders emit violet, blue, green, yellow or orange light. However, these powders are often sulfides which are not chemically stable. Take wildly used zinc sulfide compound as an example, while utilized as a product exposed under the sunlight, due to moisture and ultraviolet ray, the compound is darkened by photolysis effect and it will result in luminosity reduction. And it can only be used for in room services such as night light clock or emergency guiding sign. Moreover, zinc sulfide compound is not practical since its afterglow can only be identified by naked eyes for 30 minutes to 2 hours. For better efficacy, the adding of radiative matter supplement is necessary.

The particle size of luminant powder depends on following applications. Primary synthesized luminant powder contains different-size-granule mixture. Traditionally, machinery vibration is used to sieve luminant powder out; and only one mesh can be used each time. Accordingly, it takes lots of time and efforts to repeat the sieving process and obtain powder with required size.

Therefore, the present invention tries to develop luminant powder with stable, light resistant, and superior afterglow properties. Also, it develops a faster and more efficient method for manufacture and selection of luminant powder.

### SUMMARY OF THE INVENTION

In view of the disadvantages in the prior art, the present invention intends to provide luminant powder and method for producing the same to acquire luminant powders with required size.

The other purpose of the present invention is to provide a method for coating of luminant powders to obtain ruminant powders with high stability providing stable and long term emission characteristic.

To achieve said purposes above, the present invention relates to a method of producing of luminant powders, comprising: (a)mixing raw materials of compounds containing metallic elements to obtain a mixture; (b)adding activated carbon into the mixture of step (a) for sintering to obtain sintered products; (c)Grinding the sintered product of step (b) to obtain grinded products; and (d)Sieving the grinded products of step (c).

The method is characterized by carried out the step (d) with series of sieves, which are arranged from large to small mesh, to sieve out luminant powders with different particle size.

The present invention also relates to a method for coating luminant powders, comprising: (a)providing luminant powders in a container; (b)adding and stirring phosphoric acid into said container to coat the phosphoric acid onto the surface of luminant powders to obtain coated luminant powders; (c)immersing the coated luminant powders of step (b) in water for 2˜5 hours; and (d)drying the product of step (c).

The formula of said luminant powders is MAl₂O₄ and M is selected from Sr, Ba or Ca.

In addition, the present invention relates to a luminant powders coated with phosphoric acid.

In one preferred embodiment, the luminant powders coated with phosphoric acid is produced by the above method for coating of luminant powder.

Required-sized luminant powders can be directly obtained through ruminant powders producing method of the present invention. Further, the surface of ruminant powder coated with a layer of phosphoric acid can increase the stability of the powder which can thereby resist temperature as high as 400˜500° C. Even though the powder is affected by damp (immersed in water for 300 hours), its luminosity will not decrease. Upon moisture, reduction of emission ability and luminosity of conventional non-coated or silicon-coated powders can be avoided in the present invention. Luminant powders in the present invention can be applied as a coating layer on the surface of commodities to increase the resistance to temperature, friction or varieties of processing materials, such as fabric, leather PVC plastic, injection molding raw material, gauze, embroidery, lace, nail polish, tattoo sticker, fluorescent stick, bracelet, trademark, keyboard or shell of computer or mobile phone, sticker of safety instruction and exit, door plate, traffic sign, stage background, house decoration and handicraft etc.

### BRIEF DESCRIPTION OF THE DRAWINGS

FIG. 1 shows the flow chart of winnowing sieving of luminant powder of the present invention.

### DETAILED DESCRIPTION OF THE INVENTION

The producing of luminant powders of the present invention comprises detailed steps as following: first, mix raw material compounds containing metallic elements, wherein metallic elements in the compounds are selected from aluminium (Al), strontium (Sr), barium (Ba), dyspronium (Dy), europium (Eu) or calcium (Ca). Further, metallic compounds contain aluminium oxide, strontium carbonate, europium oxide, dysprosium oxide, barium carbonate or calcium carbonate. Boric acid can be further added into pre-mixture after acquiring raw materials and prior to mixing. The purpose of mixing is to uniformly contact aluminium oxide and strontium carbonate with other metallic compounds. The method is well known in the skilled art, like churning zirconium beads into an aluminium can containing raw materials.

After mixing process, add activated carbon subsequently into the mixture for sintering at 1250˜1350° C. for 8˜12 hours, then settle it for 4˜6 hours. Afterwards, grind the product to break it upon completion of the sintering. Finally, select product with specific size after grinding.

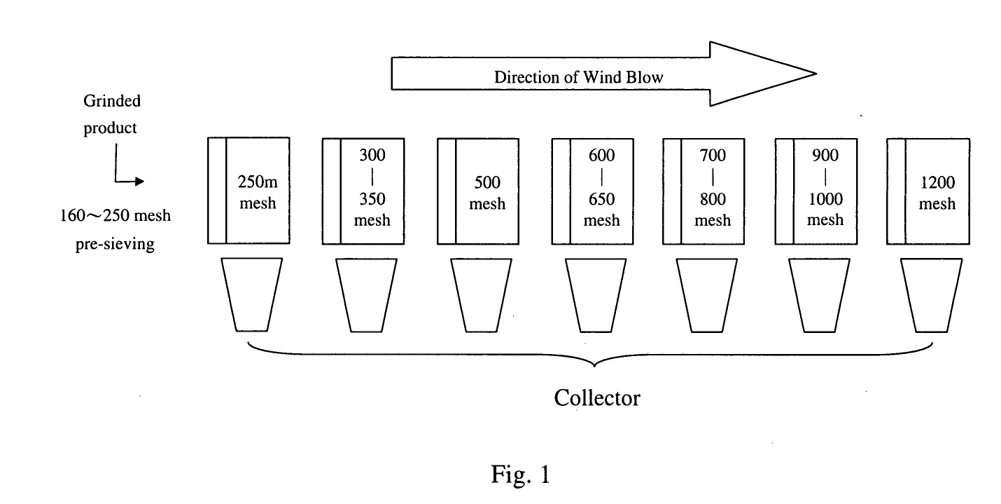

Traditional selection makes product pass through meshes arranged from large-sized mesh to small-sized mesh. Generally, meshes with 160˜250 mesh are used first. 10%˜15% of the product after sieving has size around 500 mesh; 7%˜10% has 700˜800 mesh; 5%˜10% has 1200 mesh. For powders with 500 or more mesh, sieving it by machinery vibration is slow and time consuming. Therefore, the present invention is characterized by winnowing to sieve out the product after grinding. As shown in FIG. 1, before winnowing sieving, there can be a pre-sieving process by one mesh with 160˜250 mesh. Then, make product after pre-sieving pass through multiple meshes arranged from large mesh size to small mesh size in series. In the examples of the present invention, seven meshes with mesh size from 250˜1200 arranged from large mesh size to small mesh size are used in series to sieve out and collect luminant powders with different sizes. The method of the present invention can largely accelerate the speed of sieving. Different sizes of powders are colleted after single sieving selection. The size and quantity of meshes used depend on the requirements. Formula of luminant powder prepared by method of the present invention is MAl₂O₄, wherein M is selected from Sr, Ba or Ca.

The coating method of the present invention comprises detailed steps as following: place luminant powder in one container (such as aluminium tank). Formula of the luminant powder is MAl₂O₄, wherein M is selected from Sr, Ba or Ca meaning that one embodiment of luminant powders is SrAl₂O₄.

Later on, add phosphoric acid into said container to stir for 4˜8 hours. Through the process, phosphoric acid will be coated onto the surface of luminant powders completely. Whereupon immerse the product in water at 80˜100° C. for 2˜5 ours. Prior to drying, the product can be further rinsed by water for 60˜120 minutes.

Luminant powders produced of the present invention is coated with a layer of phosphoric acid on its surface. It can resist temperature as high as 400˜500° C. Even though it is affected by damp (immersed in water for 300 hours), its luminosity will not decrease. Upon moisture, reduction of shining ability and luminosity of conventional non-coated or silicon-coated powders can be avoided in the present invention.

The following embodiments are used for further understanding of the present invention, but not limiting the claims of the present invention.

### EXAMPLE 1

### Preparation of Green Light Luminant Powder

Table 1 is a reference formula for preparing green light luminant powders containing metallic compounds.

TABLE 1

| | Compound | | | | |
|---|---|---|---|---|---|
| | SrCO₃ | Eu₂O₃ | Dy₂O3 | Al₂O₃ | H₃BO₃ |
| Wight (g) | 1525 | 108 | 56 | 1025 | 90 |
| | \| | \| | \| | \| | \| |
| | 1694 | 120 | 62 | 1281 | 100 |

Grind SrCO₃ into powders with granular size from 2 to 10 μm before mixing. Then mix the compounds with weights based on table 1. Afterwards, place the mixture into an aluminium tank and use zirconium beads to churn for 2˜4 hours. Scrape down any material sticking on the wall of the tank in order to achieve uniform mixing. The process continues until SrCO₃ and Al₂O₃ completely mixed with other compounds.

Add few activated carbon in to the completely mixed mixture above. Thereafter, sinter the product at 1250° C.˜1350° C. for 8˜12 hours; then settle it for 4˜6 hours. Grind the product after sintering to break it and use a mesh with 160˜250 mesh to conduct pre-sieving. Finally, seven meshes with mesh from 250˜1200 (such as, 250 mesh, 300˜350 mesh, 500 mesh, 600˜650 mesh, 700˜800 mesh, 900˜1000 mesh and 1200 mesh), arranged from large-sized mesh to small-sized mesh (as shown in FIG. 1), are used to collect green light luminant powders with different granular sizes.

### EXAMPLE 2

### Preparation of Blue Light Luminant Powders

Table 2, reference formula for preparing blue light luminant powders containing metallic compounds.

TABLE 2

| | Compound | | | | | | |
|---|---|---|---|---|---|---|---|
| | CaCO₃ | SrCO₃ | BaCO₃ | Eu₂O₃ | Al₂O₃ | H₃BO₃ | Dy₂O₃ |
| Weight (g) | 2 | 1400 | 24 | 18 | 1680 | 18 | 18 |
| | \| | \| | \| | \| | \| | \| | \| |
| | 4 | 1750 | | 20.2 | 2100 | 20.2 | 22 |

Refer to example 1, grinding SrCO₃ into powders with granular size from 2 to 10 μm before mixing as well. Then mix the compounds with weights based on table 2. Afterwards, place the mixture into an aluminium tank and use zirconium beads to churn for 2˜4 hours. Scrape down any material sticking on the wall of the tank in order to achieve uniform mixing. The process continues until SrCO₃ and Al₂O₃ completely mixed with other compounds.

Add few activated carbon in to the completely mixed mixture above. Thereafter, sinter the product at 1250° C.˜1350° C. for 8˜12 hours; then settle it for 4˜6 hours. Grind the product after sintering to break it and use a mesh with 160˜250 mesh to conduct pre-sieving. Finally, seven meshes arranged from large-sized mesh to small-sized mesh with mesh from 250˜1200 are used to collect blue light luminant powders with different granular sizes.

### EXAMPLE 3

### Preparation of Luminant Powders Coated with Phosphoric Acid

Place luminant powders taken from example 1, example 2, or that with luminant property into a tank. Add excessive phosphoric acid into the powder and stir them with a stirring device (like an aluminium stirring stick) to fully mix up powder with phosphoric acid. Immerse the mixture in 80° C.˜100° C. pure water for 2˜5 hours, then wash it with water 60˜120 minutes. Last, dry the mixture above in oven to acquire luminant powders coated with phosphoric acid.

### EXAMPLE 4

### Test of Emission Ability of Luminant Powders

The emission ability of the luminant powders was tested by Centre of Measurement Standards of ITRI, Taiwan. The method illuminated the blue light luminant powder and the green light luminant powders with 1000 1× low voltage fluorescent light (daylight lamp) for 5 minutes then turning light off; then detected the emission brightness (mcm/m²) in the dark. The standard light source brightness is complied with that of National Measurement Laboratory R.O.C.; and the calibration of dispersion light radiating system brightness chromometer was based on the procedures of Center of Measurement Standards of ITRI. The emission abilities of green light luminant powders and blue light luminant powders are shown in table 3 and table 4 below:

TABLE 3
Emission of green light luminant powders

| Time | Strength |
|---|---|
| (minute) | (mcd/m²) |
| 1 | 2149.8 |
| 2 | 1376.9 |
| 3 | 1031.2 |
| 4 | 829.3 |
| 5 | 695.4 |
| 10 | 387.0 |
| 15 | 268.7 |
| 20 | 205.6 |
| 25 | 166.2 |
| 30 | 139.2 |
| 60 | 69.8 |
| 90 | 45.9 |
| 120 | 33.7 |
| 180 | 21.5 |
| 240 | 15.4 |
| 300 | 11.8 |
| 360 | 9.5 |
| 420 | 7.8 |
| 480 | 6.6 |
| 540 | 5.7 |
| 600 | 4.9 |
| 660 | 4.4 |
| 720 | 3.9 |
| 780 | 3.5 |
| 840 | 3.1 |
| 900 | 2.8 |

TABLE 4
Emission test of blue light luminant powders

| Time | Strength |
|---|---|
| (minute) | (mcd/m²) |
| 1 | 864.0 |
| 2 | 646.3 |
| 3 | 521.9 |
| 4 | 439.9 |
| 5 | 380.7 |
| 10 | 227.9 |
| 15 | 161.8 |
| 20 | 124.8 |
| 25 | 101.1 |
| 30 | 84.7 |
| 60 | 41.3 |
| 90 | 26.5 |
| 120 | 19.2 |
| 180 | 11.9 |
| 240 | 8.4 |
| 300 | 6.3 |
| 360 | 5.0 |
| 420 | 4.1 |
| 480 | 3.4 |
| 540 | 2.9 |
| 600 | 2.5 |
| 660 | 2.2 |
| 720 | 1.9 |
| 780 | 1.7 |
| 840 | 1.5 |
| 900 | 1.4 |

From table 3 and table 4, green light luminant powders the blue light luminant powders in the present invention indeed have long term luminant property.

### EXAMPLE 5

### Test of Emission Ability of Luminant Powders applications

Like example 4, the emission ability test was carried out by Centre of Measurement Standards of ITRI, Taiwan. subjects being measured were fluorescent acrylics plate (blue light) and fluorescent sticker (green light); both of them were mixed with luminant powders of the present invention. The emission abilities of are shown in table 5 and table 6 below:

TABLE 5
Emission test of fluorescent acrylics plate (blue light)

| Time | Strength |
|---|---|
| (minute) | (mcd/m²) |
| 1 | 761.6 |
| 2 | 581.5 |
| 3 | 475.5 |
| 4 | 403.8 |
| 5 | 351.3 |
| 10 | 211.9 |
| 15 | 150.4 |
| 20 | 116.0 |
| 25 | 94.1 |
| 30 | 78.9 |
| 60 | 38.5 |
| 90 | 24.9 |
| 120 | 17.9 |
| 180 | 11.2 |
| 240 | 7.9 |
| 300 | 6.1 |
| 360 | 4.8 |
| 420 | 4.0 |
| 480 | 3.4 |
| 540 | 2.9 |
| 600 | 2.5 |
| 660 | 2.2 |
| 720 | 2.0 |
| 780 | 1.8 |
| 840 | 1.6 |
| 900 | 1.5 |

TABLE 6
Emission test of fluorescent sticker (green light)

| Time | Strength |
|---|---|
| (minute) | (mcd/m²) |
| 1 | 926.9 |
| 2 | 514.2 |
| 3 | 354.9 |
| 4 | 269.5 |
| 5 | 216.5 |
| 10 | 107.0 |
| 15 | 69.7 |
| 20 | 51.2 |
| 25 | 40.2 |
| 30 | 32.9 |
| 60 | 14.8 |
| 90 | 9.1 |
| 120 | 6.4 |
| 180 | 3.8 |
| 240 | 2.5 |
| 300 | 1.8 |
| 360 | 1.3 |
| 420 | 1.0 |
| 480 | 0.8 |
| 540 | 0.6 |
| 600 | 0.4 |
| 660 | 0.3 |
| 720 | 0.2 |
| 780 | 0.2 |
| 840 | 0.1 |
| 900 | 0.0 |

Standard emission strengths of general night light strip are 9.5 mcd/m² in 60 minutes and 0.3 mcd/m² in 360 minutes. From table 5 and table 6, emission strengths of luminant strip made by luminant powders of the present invention are 14.8 mcd/m² in 60 minutes and 1.3 mcd/m² in 360 minutes; the values are apparently higher than the standard values. From this may prove that luminant powders in the present invention can be practically used in commodities and it is characterized by long term luminant property.

In summary, required-sized ruminant powders can be directly produced by luminant powders preparation method in the present invention. Further coated surface of the luminant powders with a layer of phosphoric acid can increase the stability of the powders resisting temperature as high as 400° C.˜500° C. Even though affected by damp (immersed in water for 300 hours), there will be no brightness reduction on applications such as the coatings on the surfaces of commodities or other processing materials.

Other Embodiments

All properties disclosed in the present specification can be combined with other methods. Every characteristic disclosed in the present specification can be optionally replaced by equal or similar characteristic. Consequently, in addition to particularly obvious characteristics, all characteristics in the present specification are examples of equal or similar characteristics.

Though preferred embodiment of the present invention is disclose above, it is not used to limit the present invention. Any person skilled in the art can make any change and modification within the scope and spirit of the present invention.

What is claimed is:

1. A method for producing luminant powders, comprising:
(a) mixing raw materials of compounds containing metallic elements to obtain a mixture;
(b) adding activated carbon into the mixture of step (a) for sintering to obtain a sintered product;
(c) Grinding the sintered product of step (b) to obtain a grinded product; and
(d) Sieving the grinded product of step (c);
said method is characterized by carried out the step
(d) with series of sieves, which are arranged from large mesh to small mesh, to sieve out luminant powders with different particle size.

2. The method according to claim 1, wherein said compounds comprises metallic elements selected from aluminium (Al), strontium (Sr), barium (Ba), dyspronium (Dy), europium (Eu) or calcium (Ca).

3. The method according to claim 1, wherein said compounds comprise aluminium oxide, strontium carbonate, europium oxide, dysprosium oxide, barium carbonate or calcium carbonate.

4. The method according to claim 1, wherein said luminant powders is provided with formula of MAl₂O₄, wherein M is selected from Sr, Ba or Ca.

5. The method according to claim 1, which further comprises a step of adding of boric acid into the mixture in said step (a).

6. The method according to claim 1, wherein the sintering temperature is 1250° C.˜1350° C.

7. The method according to claim 1, which further comprises a pre-sieving step proceeded with a 160˜250 mesh sieve mesh between step (c) and step (d).

8. The method according to claim 1, wherein the sieving of step (d) is carried out with seven meshes arranged in the order of mesh size from large to small.

9. The method according to claim 8, wherein said seven meshes are provided with mesh size between 250˜1200 mesh.

10. A method for coating of luminant powders, comprising:
(a) providing luminant powders in a container;
(b) adding and stirring phosphoric acid into said container to coat the phosphoric acid onto the surface of luminant powders to obtain coated ruminant powders;
(c) immersing the coated luminant powders in water for 2˜5 hours; and
(d) drying the product of step (c).

11. The method according claim 10, wherein said luminant powders is provided with formula of MAl₂O₄, wherein M is selected from Sr, Ba or Ca.

12. The method according to claim 11, wherein said luminant powders is SrAl₂O₄.

13. The method according to claim 10, wherein said stirring in step (b) lasts for 4˜8 hours.

14. The method according to claim 10, which further comprises a rinsing step between step (c) and step (d), which is proceeded by rinsing the product of step (c) with water for 60˜120 minutes.

15. A luminant powders coated with phosphoric acid.

16. The luminant powders according to claim 15, which is provided with formula of MAl₂O₄, wherein M is selected from Sr, Ba or Ca.

17. The luminant powder according to claim 16, wherein said luminant powders is SrAl₂O₄.

18. The luminant powder according claim 15, wherein said luminant powders is producing by the method described in claim 10.
